(19) United States
(12) Patent Application Publication
(10) Pub. No.: US 2025/0070174 A1
(43) Pub. Date: Feb. 27, 2025

(54) BATTERY ELECTRODE

(71) Applicant: GM GLOBAL TECHNOLOGY OPERATIONS LLC, Detroit, MI (US)

(72) Inventors: Nathaniel Hardin, Farmington Hills, MI (US); Fang Dai, Troy, MI (US); Adam Van Wiemeersch, Novi, MI (US)

(21) Appl. No.: 18/456,109

(22) Filed: Aug. 25, 2023

(51) Int. Cl. H01M 4/62; C08F 8/44; H01M 4/38; H01M 10/0525; H01M 10/0568; H01M 10/0569

(52) U.S. Cl. CPC H01M 4/622; C08F 8/44; H01M 4/382; H01M 4/625; H01M 10/0525; H01M 10/0568; H01M 10/0569; H01M 2004/027; H01M 2004/028; H01M 2300/0028

(57) ABSTRACT

An electrode for an electrochemical cell is provided herein as well an electrochemical cell including the electrode. The electrode includes an electroactive material; an electrically conductive material; and a binder comprising a lithiated maleic anhydride copolymer.

### INTRODUCTION

The present disclosure relates to electrodes, for example sulfur-containing electrodes, for use in lithium-ion electrochemical cells and methods of forming the same.

Advanced energy storage devices and systems are in demand to satisfy energy and/or power requirements for a variety of products, including automotive products such as start-stop systems (e.g., 12 volt (V) start-stop systems), battery-assisted systems, Hybrid Electric Vehicles (“HEVs”), and Electric Vehicles (“EVs”). Typical lithium-ion and lithium-sulfur batteries include at least two electrodes and an electrolyte and/or separator. One of the two electrodes serves as a positive electrode or cathode and the other electrode serves as a negative electrode or anode. Each of the electrodes is connected to a current collector (typically a metal, such as copper for the anode and aluminum for the cathode). A separator and/or electrolyte may be disposed between the negative and positive electrodes. The electrolyte is suitable for conducting lithium ions between the electrodes and, like the two electrodes, may be in various instances solid and/or liquid form and/or a hybrid thereof. In instances of solid-state batteries, which include solid-state electrodes and a solid-state electrolyte, the solid-state electrolyte may physically separate the electrodes so that a distinct separator is not required.

Lithium-sulfur batteries may include cathodes having sulfur-based electroactive materials, for example, elemental sulfur(S) and/or Li₂Sₓ where 1≤x≤8. Such cathodes often include one or more electroactive material layers, including for example a plurality of electroactive material particles, disposed on or near one or more surfaces of a current collector.

It would be desirable to develop cathodes with improved capacity and coulombic efficiency, and methods of making the same, for an electrochemical cell that can address these challenges, for example, methods and materials that may be readily integrated into common manufacturing processes.

### SUMMARY

In one exemplary embodiment, the present disclosure provides an electrode for an electrochemical cell. The electrode may include an electroactive material; an electrically conductive material; and a binder including a lithiated maleic anhydride copolymer.

In addition to one or more of the features described herein, the electrode may include, based on a total weight of the electrode: 70 to 98 weight percent of the electroactive material; 1 to 20 weight percent of the electrically conductive material; and 1 to 20 weight percent of the binder.

In another exemplary embodiment, the electroactive material may include sulfur.

In yet another exemplary embodiment, the electroactive material may include S, S₈, Li₂S₈, Li₂S₆, Li₂S₄, Li₂S₂, Li₂S, or a combination thereof.

In yet another exemplary embodiment, the electrically conductive material may include carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, or a combination thereof.

In yet another exemplary embodiment, the lithiated maleic anhydride copolymer may be formed by lithiating a maleic anhydride copolymer represented by formula I:

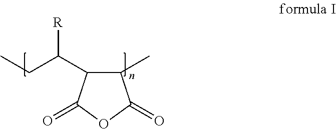

wherein R is an alkyl, an ether, a sulfate, an amide, an ester, or a nitrate.

In yet another exemplary embodiment, the lithiated maleic anhydride copolymer may include poly (methyl vinyl ether-alt-lithium malate).

In one exemplary embodiment, the present disclosure provides an electrochemical cell that cycles lithium ions. The electrochemical cell may include a first electrode including a first electroactive material, an electrically conductive material, and a binder including a lithiated maleic anhydride copolymer; a second electrode including a second electroactive material; and an electrolytic material.

In addition to one or more of the features described herein, the first electrode may include, based on a total weight of the first electrode: 70 to 98 weight percent of the first electroactive material; 1 to 20 weight percent of the electrically conductive material; and 1 to 20 weight percent of the binder.

In another exemplary embodiment, the first electroactive material may include sulfur.

In yet another exemplary embodiment, the electrically conductive material may include carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, or a combination thereof.

In yet another exemplary embodiment, the lithiated maleic anhydride copolymer may be formed by lithiating a maleic anhydride copolymer represented by formula I:

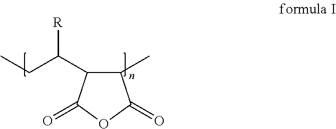

wherein R is an alkyl, an ether, a sulfate, an amide, an ester, or a nitrate.

In yet another exemplary embodiment, the lithiated maleic anhydride copolymer may include poly (methyl vinyl ether-alt-lithium malate).

In yet another exemplary embodiment, the second electroactive material may include lithium.

In yet another exemplary embodiment, the electrolytic material may include lithium salt dissolved in an organic solvent.

In yet another exemplary embodiment, the lithium salt may include lithium hexafluorophosphate, lithium perchlorate, lithium tetrachloroaluminate, lithium iodide, lithium bromide, lithium thiocyanate, lithium tetrafluoroborate, lithium difluorooxalatoborate, lithium tetraphenylborate, lithium bis-(oxalate) borate, lithium tetrafluorooxalatophosphate, lithium nitrate, lithium hexafluoroarsenate, lithium trifluoromethanesulfonate, lithium bis (trifluoromethanesulfonimide), lithium fluorosulfonylimide, lithium fluoroalkylphosphate, or a combination thereof; and the organic solvent may include a cyclic carbonate, a linear carbonate, an aliphatic carboxylic ester, a γ-lactone, a chain structure ether, a cyclic ether, a sulfur compound, or a combination thereof.

In one exemplary embodiment, the present disclosure provides a method for forming an electrode binder. The method may include obtaining a maleic anhydride copolymer; and lithiating the maleic anhydride copolymer to form the electrode binder.

In addition to one or more of the features described herein, the maleic anhydride copolymer may be represented by formula I:

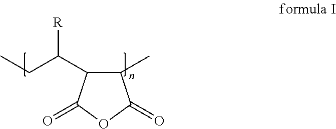

wherein R is an alkyl, an ether, a sulfate, an amide, an ester, or a nitrate.

In yet another exemplary embodiment, the maleic anhydride copolymer may include poly (methyl vinyl ether-alt-maleic anhydride).

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically shows a disassembled isometric view of a prismatic battery cell that includes an anode, an electrolytic material, a separator, and a cathode, in accordance with the disclosure;

FIG. 2 schematically illustrates a cutaway side view of an embodiment of a cathode;

FIG. 3 schematically illustrates elements of a process for forming a cathode for a battery cell;

FIG. 4 is a graphical illustration demonstrating electrochemical performance of Example 1;

FIG. 5 is a graphical illustration demonstrating electrochemical performance of Comparative Example 1;

FIG. 6 is a graphical illustration demonstrating electrochemical performance of Example 1; and

FIG. 7 is a graphical illustration demonstrating electrochemical performance of Comparative Example 1.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, an electrode for batteries, for example, lithium-sulfur batteries, and methods of forming and using the same are disclosed. Such batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. The present disclosure provides a rechargeable lithium-ion battery that exhibits improved capacity and coulombic efficiency.

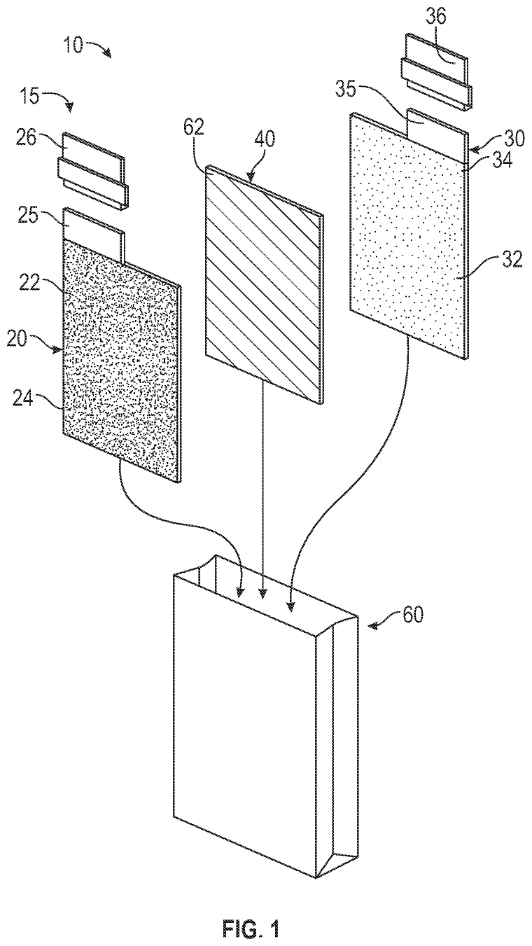

Referring to the drawings, wherein like reference numerals correspond to like or similar components throughout the several Figures, FIG. 1 schematically illustrates an embodiment of a prismatically-shaped lithium ion battery cell 10 that includes an electrode pair 15 having a cathode 20, a separator 40, and an anode 30 that are arranged in a stack and sealed in a flexible pouch 60 containing an electrolytic material 62. In an embodiment of the battery cell, a reference electrode may be arranged between the anode and the cathode. A first, positive battery cell tab 26 and a second, negative battery cell tab 36 protrude from the flexible pouch 60. The terms “anode” and “negative electrode” are used interchangeably. The terms “cathode” and “positive electrode” are used interchangeably. A single electrode pair 15 including an arrangement of the cathode 20, separator 40, and anode 30 is illustrated. It is appreciated that multiple electrode pairs 15 may be arranged and electrically connected in the flexible pouch 60, depending upon the application of the battery cell 10.

The cathode 20 includes a first electroactive material 22 that is arranged on a cathode current collector 24, and the cathode current collector 24 may have a foil portion 25 that extends from the first electroactive material 22 to form the second battery cell tab 26.

The anode 30 includes a second electroactive material 32 that is arranged on an anode current collector 34. The anode current collector 34 may be a metallic substrate with a foil portion 35 that extends from the second electroactive material 32 to form the first battery cell tab 36.

The cathode and anode current collectors 24, 34 may be metallic plate-shaped elements that contact respective first and second electroactive materials 22, 32 over an appreciable interfacial surface area. The purpose of the cathode and anode current collectors 24, 34 is to exchange free electrons with respective first and second electroactive materials 22, 32 during discharging and charging.

The cathode current collector 24 may be a metallic substrate in the form of a planar sheet that is fabricated from aluminum or an aluminum alloy, and may have a thickness of, for example, 0.02 millimeters (mm). The separator 40 is arranged between the cathode 20 and the anode 30 to physically separate and electrically isolate the anode 30 from the cathode 20.

The anode current collector 34 may be a flat, plate-shaped metallic substrate in the form of a rectangular planar sheet in an embodiment. In an embodiment, the anode current collector 34 may be arranged as a planar sheet having a non-rectangular shape, a coiled configuration, a cylindrical configuration, or another configuration.

The anode current collector 34 may be fabricated from one of copper, copper alloy, stainless steel, nickel, etc., or another material that does not alloy with lithium. In an embodiment, the anode current collector 34 may have a thickness of, for example, 0.02 mm. The second electroactive material 32 is present in a second electroactive material layer that may be applied onto one or both surfaces of the anode current collector 34.

The cathode current collector 24, the anode current collector 34, or a combination thereof may include stainless steel, aluminum, nickel, iron, titanium, copper, tin, a suitable electrically conductive material, or a combination thereof. The cathode current collector 24, the anode current collector 34, or a combination thereof may be a cladded foil, for example, where one side (e.g., the first side or the second side) of the current collector 24, 34 includes one metal (e.g., first metal) and another side (e.g., the other side of the first side or the second side) of the current collector 24, 34 includes another metal (e.g., second metal). The cladded foil may include, for example, aluminum-copper (Al—Cu), nickel-copper (Ni—Cu), stainless steel-copper (SS—Cu), aluminum-nickel (Al—Ni), aluminum-stainless steel (Al—SS), and nickel-stainless steel (Ni—SS). The cathode current collector 24, the anode current collector 34, or a combination thereof may be pre-coated, such as graphene or carbon-coated aluminum current collectors. The cathode current collector 24, the anode current collector 34, or a combination thereof may be in the form of a foil, slit mesh, woven mesh, or a combination thereof.

The electrolytic material 62 that conducts lithium ions may be contained within the separator 40 and may be exposed to each of the cathode 20 and the anode 30 to permit lithium ions to move between the cathode 20 and the anode 30. Lithium ions may be stripped from the anode 30 during discharge, or from the cathode 20 during charge give up electrons that flow through the current collectors 34 and 24, respectively, through an external circuit connected either to a load or a charger, and then to the opposite current collectors (24 and 34) and electrodes (20 and 30) where they reduce lithium ions as they are being intercalated.

The cathode 20 and the anode 30 are each fabricated as electrode materials that are able to deposit and strip the lithium ions (on an anode), or intercalate and de-intercalate (on a cathode). The electrode materials of the cathode 20 and the anode 30 are formulated to store lithium at different electrochemical potentials relative to a common reference electrode (e.g., lithium). In the construct of the electrode pair 15, the anode 30 stores deposited or plated lithium at a lower electrochemical potential (i.e., a higher energy state) than the cathode 20 such that an electrochemical potential difference exists between the cathode 20 and the anode 30 when the anode 30 is lithiated. The electrochemical potential difference for each battery cell 10 may result in a charging voltage in the range of 3 V to 5 V and nominal open circuit voltage in the range of 2.9 V to 4.2 V, which may permit the reversible transfer of lithium ions between the cathode 20 and the anode 30 either spontaneously (discharge phase) or through the application of an external voltage (charge phase) during operational cycling. The thickness of the anode 30 is between 10 μm and 20 μm in an embodiment.

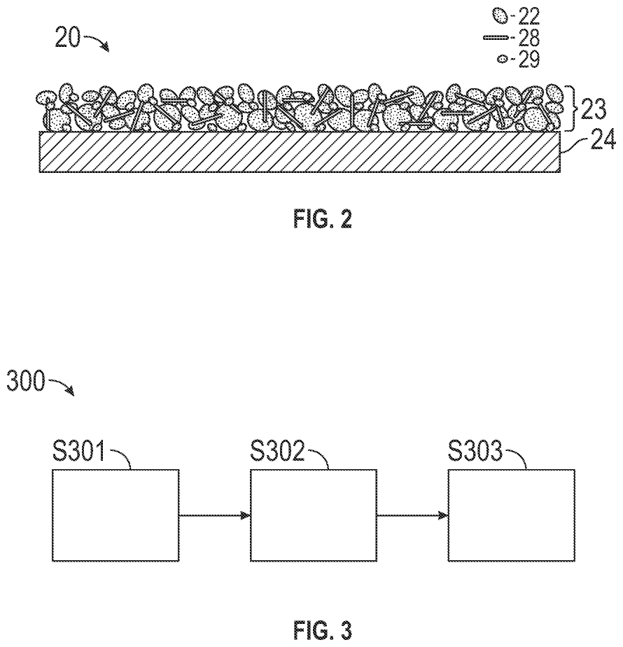

The first electroactive material layer 23, FIG. 2, of the cathode 20 includes first electroactive material 22, a first electrically conductive material 28, and a lithiated maleic anhydride copolymer binder 29. The cathode may include, based on total weight of the cathode, 30 wt. % to 98 wt. % of the first electroactive material, greater than 0 wt. % to 30 wt. % of the first electrically conductive material, greater than 0 wt. % to 20 wt. % of the lithiated maleic anhydride copolymer binder, and 0 wt. % to 30 wt. % of electrolytic material.

The cathode may be in the form of a layer having a thickness from 1 μm to 1,000 μm, for example, from 5 μm to 400 μm or from 10 μm to 300 μm. The cathode may be defined by a plurality of first electroactive material, for example, including the first electroactive material. The first electroactive material may have an average particle diameter from 0.01 μm to 50 μm, for example, from 1 μm to 20 μm.

The first electroactive material may be an electroactive material including sulfur such as S, S₈, Li₂S₈, Li₂S₆, Li₂S₄, Li₂S₂, Li₂S, or a combination thereof. The electroactive material including sulfur should sufficiently undergo lithiation and delithiation while functioning as a positive terminal of the battery cell.

The first electroactive material may be present in the cathode in an amount greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, based on total weight of the cathode; or from 50 wt. % to 99 wt. %, 70 wt. % to 99 wt. %, or 90 wt. % to 99 wt. %, based on total weight of the cathode.

The cathode 20 may include a first electrically conductive material 28. For example, the first electroactive material 22 may be intermingled with the first electrically conductive material 28 that provides an electron conduction path. The first electrically conductive material 28 may be present in the cathode 20 in an amount from 1 wt. % to 20 wt. %, 1 wt. % to 15 wt. %, or 1 wt. % to 10 wt. %, based on total weight of the cathode 20.

Examples of the first electrically conductive material 28 include, for example, carbon black (such as, Super P), graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), a liquid metal (e.g., Ga, GaInSn), a conductive polymer (e.g., include polyaniline, polythiophene, polyacetylene, polypyrrole, and the like), or a combination thereof. As used herein, the term “graphene nanoplatelet” refers to a nanoplate or stack of graphene layers. Such first electrically conductive material 28 in particle form may have a round geometry or an axial geometry.

The term “axial geometry” refers to particles generally having a rod, fibrous, or otherwise cylindrical shape having an evident long or elongated axis. An aspect ratio (AR) for cylindrical shapes (e.g., a fiber or rod) may be defined as AR=L/D where L is the length of the longest axis and D is the diameter of the cylinder or fiber. Exemplary axial-geometry electroactive material particles suitable for use in the present disclosure may have high aspect ratios, ranging from 10 to 5,000, for example. The first electroactive material particles having an axial-geometry include fibers, wires, flakes, whiskers, filaments, tubes, rods, and the like. The term “round geometry” typically applies to particles having lower aspect ratios, for example, an aspect ratio closer to 1 (e.g., less than 10). It should be noted that the particle geometry may vary from a true round shape and, for example, may include oblong or oval shapes, including prolate or oblate spheroids, agglomerated particles, polygonal (e.g., hexagonal) particles or other shapes that generally have a low aspect ratio. Oblate spheroids may have disc shapes that have relatively high aspect ratios. Thus, a generally round geometry particle is not limited to relatively low aspect ratios and spherical shapes.

The cathode 20 includes a lithiated maleic anhydride copolymer binder 29, for example, to structurally fortify the first electroactive material 22. For example, the first electroactive material 22 may be intermingled with a lithiated maleic anhydride copolymer binder 29 that improves the structural integrity of the cathode 20. The lithiated maleic anhydride copolymer binder 29 may be present in the cathode 20 in an amount from 1 wt. % to 20 wt. %, 1 wt. % to 15 wt. %, or 1 wt. % to 10 wt. %, based on total weight of the cathode 20.

In an embodiment, the lithiated maleic anhydride copolymer binder may demonstrate less capacity fade, provide a more robust mechanical network and improved mechanical properties to handle silicon particle expansion more effectively, and possess good chemical and thermal resistance.

Examples of suitable maleic anhydride copolymers that may be lithiated to provide a lithiated maleic anhydride copolymer binder 29 as described herein, include, for example,

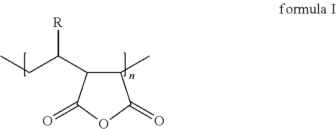

wherein R is an alkyl, ether, sulfate, amide, ester, nitrate, or other moiety that will not react with an anhydride moiety (e.g., the anhydride moiety of the maleic anhydride copolymer). For example, poly(methyl vinyl ether-alt-maleic anhydride) may be lithiated to provide a lithiated maleic anhydride copolymer (e.g., poly(methyl vinyl ether-alt-lithium malate)) as follows:

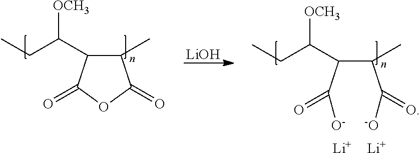

Without wishing to be bound by any theory, it is believed that the lithiation (e.g., of maleic anhydride) may increase lithium ion transport. The different side groups, such as ethers, may help improve ion transport, and increase solution wettability and different swelling properties.

A process of lithiating a maleic anhydride copolymer may include dissolving the maleic anhydride copolymer in water, adding lithium hydroxide, and drying the resulting lithiated maleic anhydride copolymer. Liathiation may be conducted at a temperature of, for example, less than 100° C. or less than 70° C.

FIG. 2 schematically illustrates an embodiment of the cathode 20, which includes the cathode current collector 24 having a first electroactive material layer 23 thereon, after drying a first electroactive material slurry. In an embodiment and as shown, the first electroactive material layer 23 may be applied onto one side of the cathode current collector 24. The first electroactive material layer 23 may be applied onto both sides of the cathode current collector 24. The first electroactive material layer 23 includes 70 wt. % to 98 wt. % of the first electroactive material 22, 1 wt. % to 20 wt. % of the first electrically conductive material 28, and 1 wt. % to 20 wt. % of the lithiated maleic anhydride copolymer binder 29, based on total weight of the first electroactive material layer 23.

In an embodiment, the first electroactive material layer 23 may have a thickness between 4 μm and 12 μm. In an embodiment, the first electroactive material layer 23 may have a thickness between, for example, 35 μm and 150 μm.

The first electroactive material slurry includes a mixture of the first electroactive material 22, the first electrically conductive material 28, the lithiated maleic anhydride copolymer binder 29 and a solvent. The first electroactive material 22 may have a maximum particle size of 10 μm and minimum particle size of 100 nm, with a purity minimum of 99.0%.

The lithiated maleic anhydride copolymer binder 29 serves as a binding material to join the first electrically conductive material 28, the first electroactive material 22, and the cathode current collector 24. The lithiated maleic anhydride copolymer binder 29 may be in the form of a powder, a resin, or dissolved in the solvent.

The mixture of the first electroactive material 22, the first electrically conductive material 28, and the lithiated maleic anhydride copolymer binder 29 that forms the first electroactive material layer 23 is formed into the first electroactive material slurry employing an organic solvent or water by mixing, as illustrated by Step S301 of process 300 of FIG. 3. The first electroactive material slurry including the first electroactive material layer 23 may be applied (e.g., cast) onto the cathode current collector 24, as illustrated by Step S302 of process 300 of FIG. 3, and dried to form a cathode.

The first electroactive material layer 23 may be applied onto the cathode current collector 24 by gravure coating, slot die coating, or dip coating in an embodiment. Slot-die coating is a deposition technique in which the first electroactive material 22 slurry is delivered onto the substrate of the cathode current collector 24 via a narrow slot positioned close to the surface. A major advantage of the slot-die coating method is the simple relationship between wet-film coating thickness, the flow rate of solution, and the speed of the coated substrate relative to the head. In addition, slot-die coating is capable of achieving extremely uniform films across large areas. Slot-die coating is one of many methods that may be used to deposit a thin liquid film onto the surface of a substrate. One of the main advantages of slot-die coating is that it may easily be integrated into scale-up processes including roll-to-roll coating and sheet-to-sheet deposition systems.

The first electroactive material slurry including the first electroactive material layer 23 may be applied onto the cathode current collector 24 by dipping the cathode current collector 24 into a bath including the first electroactive material slurry in an embodiment.

The cathode current collector 24 having the first electroactive material layer 23 applied thereon is subjected to a drying process to bind the first electroactive material layer 23 onto the surface of the cathode current collector 24 to form the cathode 20, as illustrated by Step S303 of process 300 of FIG. 3. The drying process may include subjecting the cathode current collector 24 with the applied first electroactive material layer 23 to an elevated temperature environment for a period of time to remove the solvent, which may include subjecting the cathode current collector 24 with the applied first electroactive material layer 23 to a calendering process to improve adhesion of the first electroactive material layer 23 onto the surface of the cathode current collector 24. The cathode current collector 24 with the applied first electroactive material layer 23 is subjected to a temperature between 60° C. and 150° C. for a period of 1 to 60 minutes to dry and remove the solvent after binding the first electroactive material layer 23 onto the surface of the cathode current collector 24.

An electroactive material layer of the anode may include second electroactive material, a second electrically conductive material, and a second binder. The anode may include, based on total weight of the anode, 30 wt. % to 100 wt. % of the second electroactive material, 0 wt. % to 30 wt. % of the second electrically conductive material, 0 wt. % to 20 wt. % of the second binder, and 0 wt. % to 30 wt. % of electrolytic material.

The anode may be in the form of a layer having a thickness from 1 μm to 1,000 μm, for example, from 5 μm to 400 μm or from 10 μm to 300 μm. The anode may be defined by a plurality of second electroactive material, for example, including the second electroactive material. The second electroactive material may have an average particle diameter from 0.01 μm to 50 μm, for example, from 1 μm to 20 μm.

The anode includes a second electroactive material as a lithium host material capable of functioning as a negative terminal of a lithium ion battery. For example, the anode may include a lithium host material (e.g., second electroactive material) that is capable of functioning as a negative terminal of the battery cell. The anode may be defined by a plurality of second electroactive material particles.

The anode may include a second electroactive material including lithium, for example, lithium metal, a lithium alloy (such as, for example, a lithium silicon alloy, a lithium aluminum alloy, a lithium indium alloy, a lithium tin alloy, or a combination thereof), or a combination thereof. The anode may further include silicon, tin oxide, aluminum, indium, zinc, germanium, silicon oxide, titanium oxide, lithium titanate, iron sulfide (FeS), Li₄Ti₅O₁₂, or a combination thereof, for example, silicon mixed with graphite. The anode may be lithium metal itself. In an embodiment, the anode may include lithiated graphite.

The second electroactive material may be present in the anode in an amount from 70 wt. % to 100 wt. %, 70 wt. % to 98 wt. %, 70 wt. % to 95 wt. %, 80 wt. % to 95 wt. %, based on total weight of the anode.

The anode may include a second electrically conductive material. For example, the second electroactive material may be intermingled with the second electrically conductive material that provides an electron conduction path. The second electrically conductive material may be present in the anode in an amount from 0 wt. % to 30 wt. %, 1 wt. % to 25 wt. %, 1 wt. % to 20 wt. %, 1 wt. % to 10 wt. %, 3wt. % to 20 wt. %, or 5 wt. % to 15 wt. %, based on total weight of the anode.

The second electrically conductive material may be the same as or different from the first electrically conductive material and may include, for example, carbon black (such as, Super P), graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), a liquid metal (e.g., Ga, GaInSn), a conductive polymer (e.g., include polyaniline, polythiophene, polyacetylene, polypyrrole, and the like), or a combination thereof.

The anode may include a second binder. For example, the second electroactive material may be intermingled with a second binder that improves the structural integrity of the anode. The second binder may be present in the anode in an amount from 0 wt. % to 30 wt. %, 1 wt. % to 25 wt. %, 1 wt. % to 20 wt. %, 1 wt. % to 10wt. %, 3 wt. % to 20 wt. %, or 5 wt. % to 15 wt. %, based on total weight of the anode. The second binder may include, for example, PTFE, sodium carboxymethyl cellulose (CMC), styrene-butadiene rubber (SBR), poly (vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), or a combination thereof.

The separator may have a thickness that may be between 10 um to 50 um. The separator may include a porous polymer (e.g., polyolefin) that provides thermal stability. Examples of a polyolefin include polyethylene (PE) (along with variations such as high density polyethylene (HDPE), low density polyethylene (LDPE), linear low density polyethylene (LLDPE), and ultra high molecular weight polyethylene (UHMWPE)), polypropylene (PP), and a blend of PE and PP. The polymer may electrically insulate and physically separate the cathode and the anode.

The separator may be a solid polymer electrolytic material that includes a polymer—such as polyethylene oxide (PEO), polypropylene oxide (PPO), polyacrylonitrile (PAN), a solid electrolytic material (e.g., an oxide-based electrolytic material or a sulfide-based electrolytic material), or a gel polymer electrolytic material having a lithium salt or swollen with a lithium salt solution. The cathode and the anode reversibly exchange lithium ions through the separator during applicable discharge and charge cycles.

The separator may include, for example, a microporous polymeric separator including a polyolefin or polytetrafluoroethylene (PTFE). The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. The polyolefin may be polyethylene (PE), polypropylene (PP), or a blend of PE and PP, or multi-layered structured porous films of PE, PP, or a combination thereof, for example, a PP-PE dual layer structure or PP-PE-PP three-layer structure. Commercially available polyolefin porous separator membranes include CELGARD® 2500 (a monolayer polypropylene separator) and CELGARD® 2325 (a trilayer polypropylene/polyethylene/polypropylene separator) available from Celgard LLC.

When the separator is a microporous polymeric separator, it may be a single layer or a multi-layer laminate, which may be fabricated from either a dry or a wet process. For example, in certain instances, a single layer of the polyolefin may form the entire separator. The separator may be a fibrous membrane having an abundance of pores extending between the opposing surfaces and may have an average thickness of less than a millimeter, for example. Multiple discrete layers of similar or dissimilar polyolefins may be assembled to form the microporous polymer separator. The separator may include polymers in addition to polyolefin such as, for example, polyethylene terephthalate (PET), polyvinylidene fluoride (PVDF), a polyamide, polyimide, poly (amide-imide) copolymer, polyetherimide, cellulose, or a combination thereof, or any suitable material for creating the desired porous structure. The separator may include a cellulose separator, a PVDF membrane, and a porous polyimide membrane.

The separator may include high temperature stable polymer, such as, for example, polyimide nanofiber-based nonwovens, nano-sized Al₂O₃ and poly (lithium 4-styrenesulfonate)-coated polyethylene membrane, SiO₂ coated polyethylene, co-polyimide-coated polyethylene, polyetherimides (PEI) bisphenol-acetone diphthalic anhydride (BPADA) and para-phenylenediamine, expanded polytetrafluoroethylene reinforced polyvinylidenefluoride-hexafluoropropylene, and so on. The separator may be high temperature stable separator and include a sandwich-structured PVDF/poly (m-phenylene isophthalamide) (PMIA)/PVDF nanofibrous separator.

The separator may include a ceramic coating, a heat-resistant material coating, or a combination thereof. The ceramic coating, the heat-resistant material coating, or a combination thereof may be disposed on one or more sides of the separator. The material forming the ceramic coating may be alumina (Al₂O₃), silica (SiO₂), titania (TiO₂), or a combination thereof. The heat-resistant material may be, for example, Nomex, Aramid, or a combination thereof. The polymer (e.g., polyolefin) may be included in the separator as a fibrous layer to help provide the separator with appropriate structural and porosity characteristics.

The separator may be infiltrated with a liquid electrolytic material throughout the porosity of the polymer. The liquid electrolytic material, which wets both the cathode and the anode, may include a lithium salt dissolved in a non-aqueous solvent. The liquid electrolytic material may wet (e.g., fill, 5% to 100%, for example, 90%, of the porosity of) the separator.

The cathode, the anode, and the separator may each include the electrolytic material, for example, inside pores thereof, capable of conducting lithium ions between the anode and the cathode. Any appropriate electrolytic material, whether in solid, liquid, or gel form, capable of conducting lithium ions between the electrodes may be used in the battery cell. For example, the electrolytic material may be a non-aqueous liquid electrolyte solution that includes a lithium salt dissolved in an organic solvent or a mixture of organic solvents.

Appropriate lithium salts may have inert anions. Exemplary lithium salts that may be dissolved in an organic solvent or a mixture of organic solvents to form a non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF4), lithium difluorooxalatoborate (LiBF₂(C₂O₄)) (LiODFB), lithium tetraphenylborate (LiB(C₆H₅)₄), lithium bis-(oxalate) borate (LiB(C₂O₄)₂) (LiBOB), lithium tetrafluorooxalatophosphate (LiPF₄(C₂O₄)) (LiFOP), lithium nitrate (LiNO3), lithium hexafluoroarsenate (LiAsF₆), lithium trifluoromethanesulfonate (LiCF₃SO₃), lithium bis (trifluoromethanesulfonimide) (LiTFSI) (LIN(CF₃SO₂)₂), lithium fluorosulfonylimide (LiN(FSO₂)₂) (LiFSI), lithium fluoroalkylphosphate (LiFAP) (Li₃O₄P), or a combination thereof.

The lithium salt may be dissolved in a variety of organic solvents, including, for example, an alkyl carbonate, such as a cyclic carbonate (e.g., ethylene carbonate (EC), propylene carbonate (PC), butylene carbonate (BC), fluoroethylene carbonate (FEC)), a linear carbonate (e.g., dimethyl carbonate (DMC), diethyl carbonate (DEC), ethyl methyl carbonate (EMC)), an aliphatic carboxylic ester (e.g., methyl formate, methyl acetate, methyl propionate), a γ-lactone (e.g., γ-butyrolactone, γ-valerolactone), a chain structure ether (e.g., 1,2-dimethoxyethane (DME), 1-2-diethoxyethane, ethoxymethoxyethane), a cyclic ether (e.g., tetrahydrofuran, 2-methyltetrahydrofuran, 1,3-dioxolane (DOL)), a sulfur compound (e.g., sulfolane), or a combination thereof. The electrolytic material may include from 0.5 moles per liter (molar (M)) to 4.0 M of the one or more lithium salts. When the electrolytic material has a lithium concentration greater than 2 M or ionic liquids, the electrolytic material may include a diluter, such as fluoroethylene carbonate (FEC), hydrofluoroether (HFE), or a combination thereof.

The electrolytic material, for example, a solid-state electrolyte, may serve as both a conductor of lithium ions and a separator, such that a distinct separator component may not be present. Solid-state electrolyte particles may include oxide-based particles, sulfide-based particles, metal-doped or aliovalent-substituted oxide particles, inactive oxide particles, nitride-based particles, hydride-based particles, halide-based particles, borate-based particles, or a combination thereof.

The oxide-based particles may include a garnet ceramic, a LISICON-type oxide, a NASICON-type oxide, a Perovskite type ceramic, or a combination thereof. For example, the garnet ceramic may be Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, or a combination thereof. The LISICON-type oxide may be Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), or a combination thereof. The NASICON-type oxide may be defined by LiMM′(PO₄)₃, where M and M′ are independently Al, Ge, Ti, Sn, Hf, Zr, or La. For example, the NASICON-type oxide may be Li₁₊ₓAlₓGe₂₋ₓ(PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, or a combination thereof. The Perovskite-type ceramic may be Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), or a combination thereof.

The metal-doped or aliovalent-substituted oxide particles may include, for example, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), or a combination thereof.

The sulfide-based particles may include, for example, a pseudobinary sulfide, a pseudoternary sulfide, a pseudoquaternary sulfide, or a combination thereof. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, Li₂S—Al₂S₃ systems, Li_{3.4}Si_{0.4}P_{0.6}S₄, Li₁₀GeP₂S_{11.7}O_{0.3}, lithium argyrodite Li₆PS₅X (where X is one of Cl, Br, and I). Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ (thio-LISICON) and Li₁₀GeP₂S₁₂ (LGPS)), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}AS_{0.166}S₄), Li₂S—P₂S₅—Al₂S₃—systems, Li₂S—LiX—SiS₂ systems (where X is one of F, Cl, Br, and I), 0.4LiI·_{0.6}Li₄SnS₄, and Li₁₁Si₂PS₁₂. Example pseudoquaternary sulfide systems include Li₂O—Li₂S—P₂S₅-P₂O₅ systems, Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂. Li_{9.81}Sn_{0.81}P_{2.19}S₁₂, Li₁₀(Si_{0.5}Ge_{0.5})P₂S₁₂, Li₁₀(Ge_{0.5}Sne_{0.5})P₂S₁₂, Li₁₀(Si_{0.5}Sn_{0.5})P₂S₁₂, Li₇P_{2.9}Mn_{0.1}S_{10.7}I_{0.3}, Li_{3.833}Sn_{0.833}As_{0.166}S₄, LiI—Li₄SnS₄, Li₄SnS₄, and Li_{10.35}[Sn_{0.27}Si_{1.08}]P_{1.65}S₁₂.

The inactive oxide particles may include, for example, SiO₂, Al₂O₃, TiO₂, ZrO₂, or a combination thereof; the nitride-based particles may include, for example, Li₃N, Li₇PN₄, LiSi₂N₃, or a combination thereof; the hydride-based particles may include, for example, LiBH₄, LiBH₄—LiX (where X=Cl, Br, or I), LiNH2, Li₂NH, LiBH₄—LiNH₂, Li₃AlH₆, or a combination thereof; the halide-based particles may include, for example, Lil, Li₃InCl₆, Li₂CdCl₄, Li₂MgCl₄, LiCdI₄, Li₂ZnI₄, Li₃Ocl, Li3Ycl6, Li3Ybr6, or a combination thereof; and the borate-based particles may include, for example, Li₂B₄O₇, Li₂O—B₂O₃—P₂O₅, or a combination thereof.

The descriptions set forth herein pertaining to the cathode, the anode, the separator, and the electrolytic material are intended to be non-limiting examples. Many variations on the chemistry of each of the elements may be applied in the context of the lithium ion battery cell of the present disclosure.

### EXAMPLES

Coin cells were fabricated with a cathode having a XE2B (porous carbon host) and sulfur (in a ratio of 20 weight percent (wt. %) porous carbon to 80 wt. % encapsulated sulfur). The cathode had approximately 4.2 milligrams per square centimeter (mg/cm2) sulfur as electrochemically active material. A 13 millimeter (mm) diameter cathode has approximately 5.57 milligrams (mg) sulfur. A total weight of cathode material is approximately 8 mg of material-approximately 6.96mg of carbon/sulfur composite, approximately 0.64 mg of multi walled carbon nanotubes conductive carbon, and approximately 0.4 mg of binder (weight ratio of 87:8:5 carbon/sulfur composite: conductive carbon: binder).

The anode was a chip of lithium metal. The cell included liquid electrolytic material of 1,3-dioxolane (DOL)-1,2-dimethoxyethane (DME) 0.6 moles per liter (molar (M)) M lithium bis (trifluoromethanesulfonyl) imide (LiTFSI) 0.4 M LiNO₃ in an amount of 40 microliters (μl) and a Celgard polypropylene separator.

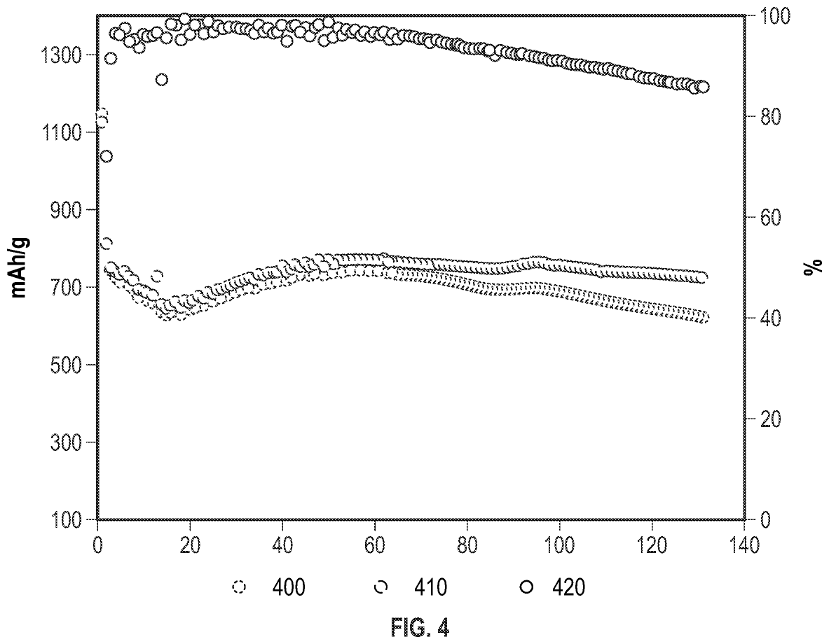

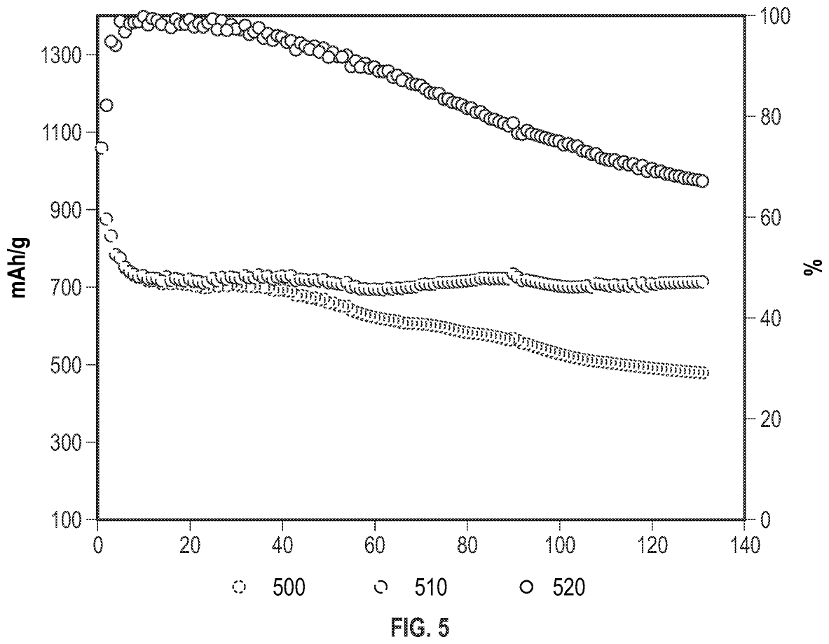

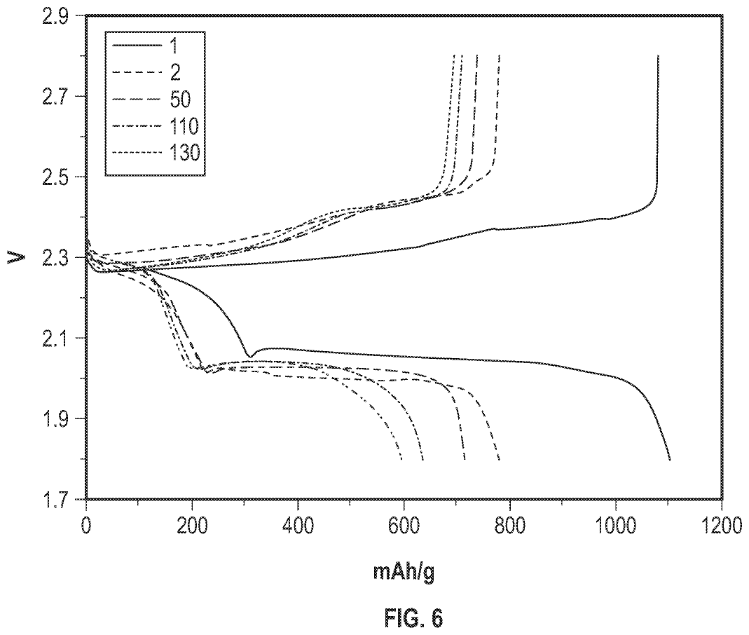

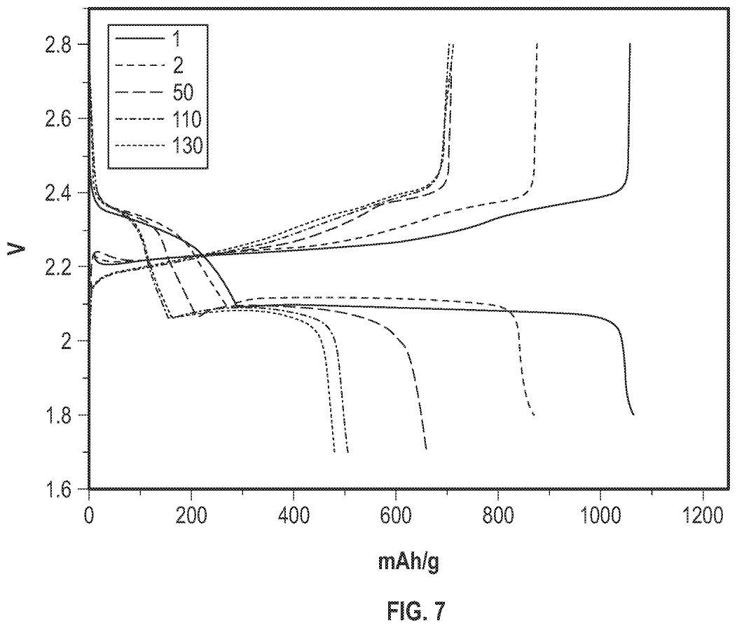

FIG. 4 is a graph of discharge specific capacity (milliampere-hours per gram (mAh/g)) (400), charge specific capacity (mAh/g) (410), and coulombic efficiency (percent (%)) (420) versus cycle number for Example 1 (poly (methyl vinyl ether-alt-lithium malate) binder) and FIG. 5 is a graph of discharge specific capacity (mAh/g) (500), charge specific capacity (mAh/g) (510), and coulombic efficiency (%) (520) versus cycle number for Comparative Example 1 (carboxymethyl cellulose (CMC) binder). FIG. 6 is a graph of voltage (volts (V)) versus specific capacity (mAh/g) for Example 1 (poly (methyl vinyl ether-alt-lithium malate) binder) and FIG. 7 is a graph of voltage (V) versus specific capacity (mAh/g) for Comparative Example 1 (CMC binder).

As seen by comparing FIG. 4 with FIG. 5 and FIG. 6 with FIG. 7, the disclosed lithiated maleic anhydride copolymer binder exhibited greater capacity and coulombic efficiency over 100 cycles. See, for example, the relatively lower level of charge separation exhibited by Example 1 as compared to Comparative Example 1, which demonstrate less energy loss. Coulombic efficiency as shown in FIG. 4 and FIG. 5 demonstrates that Examples 1 has greater stability over time when compared to Comparative Example 1. And as seen in FIG. 6 and FIG. 7, Example 1 therefore has fewer side reactions than Comparative Example 1, in which extra current may be directed to undesirable electrochemical processes as opposed to the main electrochemical performance of the cell.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electrode for an electrochemical cell, the electrode comprising:
an electroactive material;
an electrically conductive material; and
a binder comprising a lithiated maleic anhydride copolymer.

2. The electrode of claim 1, comprising, based on a total weight of the electrode:
70 to 98 weight percent of the electroactive material;
1 to 20 weight percent of the electrically conductive material; and
1 to 20 weight percent of the binder.

3. The electrode of claim 1, wherein the electroactive material comprises sulfur.

4. The electrode of claim 1, wherein the electroactive material comprises S, S₈, Li₂S₈, Li₂S₆, Li₂S₄, Li₂S₂, Li₂S, or a combination thereof.

5. The electrode of claim 1, wherein the electrically conductive material comprises carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, or a combination thereof.

6. The electrode of claim 1, wherein the lithiated maleic anhydride copolymer is formed by lithiating a maleic anhydride copolymer represented by formula I: 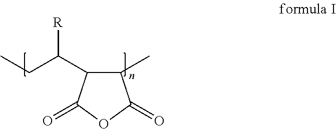
wherein R is an alkyl, an ether, a sulfate, an amide, an ester, or a nitrate.

7. The electrode of claim 1, wherein the lithiated maleic anhydride copolymer comprises poly (methyl vinyl ether-alt-lithium malate).

8. An electrochemical cell that cycles lithium ions, the electrochemical cell comprising:
a first electrode comprising
a first electroactive material,
an electrically conductive material, and
a binder comprising a lithiated maleic anhydride copolymer;
a second electrode comprising a second electroactive material; and
an electrolytic material.

9. The electrochemical cell of claim 8, wherein the first electrode comprises, based on a total weight of the first electrode:
70 to 98 weight percent of the first electroactive material;
1 to 20 weight percent of the electrically conductive material; and
1 to 20 weight percent of the binder.

10. The electrochemical cell of claim 8, wherein the first electroactive material comprises sulfur.

11. The electrochemical cell of claim 8, wherein the first electroactive material comprises S, S₈, Li₂S₈, Li₂S₆, Li₂S₄, Li₂S₂, Li₂S, or a combination thereof.

12. The electrochemical cell of claim 8, wherein the electrically conductive material comprises carbon black, graphite, acetylene black, carbon nanotubes, carbon fibers, carbon nanofibers, graphene, graphene nanoplatelets, graphene oxide, nitrogen-doped carbon, metallic powder, a liquid metal, a conductive polymer, or a combination thereof.

13. The electrochemical cell of claim 8, wherein the lithiated maleic anhydride copolymer is formed by lithiating a maleic anhydride copolymer represented by formula I: 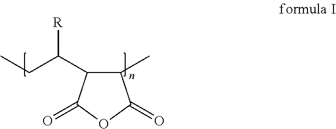
wherein R is an alkyl, an ether, a sulfate, an amide, an ester, or a nitrate.

14. The electrochemical cell of claim 8, wherein the lithiated maleic anhydride copolymer comprises poly (methyl vinyl ether-alt-lithium malate).

15. The electrochemical cell of claim 8, wherein the second electroactive material comprises lithium.

16. The electrochemical cell of claim 8, wherein the electrolytic material comprises lithium salt dissolved in an organic solvent.

17. The electrochemical cell of claim 16, wherein:
the lithium salt comprises lithium hexafluorophosphate, lithium perchlorate, lithium tetrachloroaluminate, lithium iodide, lithium bromide, lithium thiocyanate, lithium tetrafluoroborate, lithium difluorooxalatoborate, lithium tetraphenylborate, lithium bis-(oxalate) borate, lithium tetrafluorooxalatophosphate, lithium nitrate, lithium hexafluoroarsenate, lithium trifluoromethanesulfonate, lithium bis (trifluoromethanesulfonimide), lithium fluorosulfonylimide, lithium fluoroalkylphosphate, or a combination thereof; and
the organic solvent comprises a cyclic carbonate, a linear carbonate, an aliphatic carboxylic ester, a y-lactone, a chain structure ether, a cyclic ether, a sulfur compound, or a combination thereof.

18. A method for forming an electrode binder, the method comprising:
obtaining a maleic anhydride copolymer; and
lithiating the maleic anhydride copolymer to form the electrode binder.

19. The method of claim 18, wherein the maleic anhydride copolymer is represented by formula I: 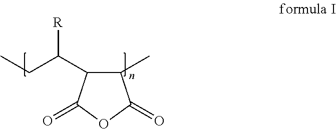
wherein R is an alkyl, an ether, a sulfate, an amide, an ester, or a nitrate.

20. The method of claim 18, wherein the maleic anhydride copolymer comprises poly (methyl vinyl ether-alt-maleic anhydride).
